(19) United States
(12) Patent Application Publication
(10) Pub. No.: US 2025/0265810 A1
(43) Pub. Date: Aug. 21, 2025

(54) INFORMATION PROCESSING DEVICE, AND DETECTION METHOD

(71) Applicant: Mitsubishi Electric Corporation, Tokyo (JP)

(72) Inventors: Eri MORIYA, Tokyo (JP); Takahiro KASHIMA, Tokyo (JP)

(73) Assignee: Mitsubishi Electric Corporation, Tokyo (JP)

(21) Appl. No.: 19/203,283

(22) Filed: May 9, 2025

Related U.S. Application Data
(63) Continuation of application No. PCT/JP2023/005718, filed on Feb. 17, 2023.

(51) Int. Cl. G06V 10/74; G06T 3/00; G06V 10/75

(52) U.S. Cl. CPC G06V 10/761; G06T 3/00; G06V 10/751; G06V 10/753

(57) ABSTRACT

An information processing device includes an acquisition unit and a detection unit. The acquisition unit of the information processing device acquires an image of a stranded wire. The detection unit of the information processing device detects a length for acquiring images of the stranded wire in a same pattern based on the image of the stranded wire.

### CROSS-REFERENCE TO RELATED APPLICATION

This application is a continuation application of International Application No. PCT/JP2023/005718 having an international filing date of Feb. 17, 2023, all of which is hereby expressly incorporated by reference into the present application.

### BACKGROUND OF THE INVENTION

### 1. Field of the Invention

The present disclosure relates to an information processing device, and a detection method.

### 2. Description of the Related Art

Stranded wires are used. For example, stranded wires are used for an electric cable. Here, a technology regarding inspection of an electric cable has been proposed (see Patent Reference 1). An automatic inspection device in the Patent Reference 1 performs extraction of an image of an abnormality candidate by dividing an image to rectangular regions independent of each other.

Patent Reference 1: Japanese Patent Application Publication No. HEI10-117415

When a stranded wire is inspected as in the above-described technology, there are cases where an image including the stranded wire is divided. When the pattern of the stranded wire in each of the divided images differs from each other, a normal stranded wire can be judged to be abnormal.

### SUMMARY OF THE INVENTION

An object of the present disclosure is to detect a length for acquiring images of the stranded wire in the same pattern.

An information processing device according to an aspect of the present disclosure is provided. The information processing device includes an acquisition unit that acquires an image of a stranded wire and a detection unit that detects a length for acquiring images of the stranded wire in a same pattern based on the image of the stranded wire.

According to the present disclosure, the length for acquiring images of the stranded wire in the same pattern can be detected.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing hardware included in an information processing device in a first embodiment;

FIG. 2 is a block diagram showing functions of the information processing device in the first embodiment;

FIG. 3 is a diagram showing an example of geometric transformation in the first embodiment;

FIGS. 4(A) and 4(B) are diagrams showing examples of calculation of a similarity level in the first embodiment;

FIG. 5 is a diagram showing a concrete example of a detection process in the first embodiment;

FIG. 6 is a flowchart showing an example of a process executed by the information processing device in the first embodiment;

FIG. 7 is a block diagram showing functions of an information processing device in a second embodiment;

FIG. 8 is a diagram showing an image example of an image after transformation in the second embodiment;

FIG. 9 is a diagram showing an example of an amplitude spectrum image in the second embodiment; and

FIG. 10 is a flowchart showing an example of a process executed by the information processing device in the second embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

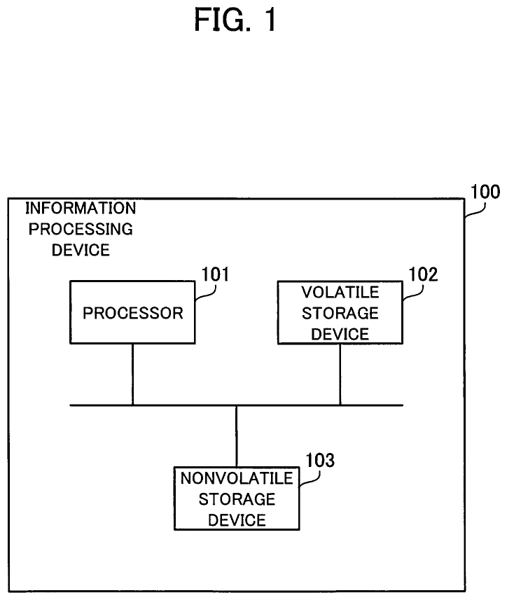

FIG. 1 is a diagram showing hardware included in an information processing device in a first embodiment. The information processing device 100 is a device that executes a detection method. The information processing device 100 includes a processor 101, a volatile storage device 102 and a nonvolatile storage device 103.

The processor 101 controls the whole of the information processing device 100. The processor 101 is a Central Processing Unit (CPU), a Field Programmable Gate Array (FPGA) or the like, for example. The processor 101 can also be a multiprocessor. Further, the information processing device 100 may include processing circuitry.

The volatile storage device 102 is main storage of the information processing device 100. The volatile storage device 102 is a Random Access Memory (RAM), for example. The nonvolatile storage device 103 is auxiliary storage of the information processing device 100. The nonvolatile storage device 103 is a Hard Disk Drive (HDD) or a Solid State Drive (SSD), for example.

Next, functions of the information processing device 100 will be described below.

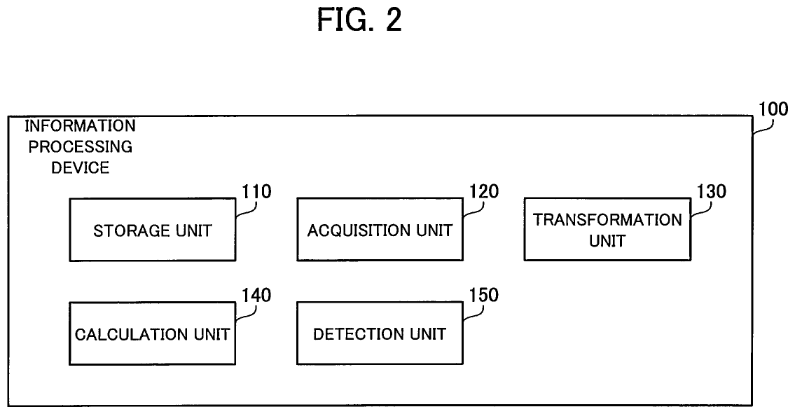

FIG. 2 is a block diagram showing the functions of the information processing device in the first embodiment. The information processing device 100 includes a storage unit 110, an acquisition unit 120, a transformation unit 130, a calculation unit 140 and a detection unit 150.

The storage unit 110 may be implemented as a storage area reserved in the volatile storage device 102 or the nonvolatile storage device 103.

Part or all of the acquisition unit 120, the transformation unit 130, the calculation unit 140 and the detection unit 150 may be implemented by processing circuitry. Further, part or all of the acquisition unit 120, the transformation unit 130, the calculation unit 140 and the detection unit 150 may be implemented as modules of a program executed by the processor 101. For example, the program executed by the processor 101 is referred to also as a detection program. The detection program has been recorded in a record medium, for example.

The storage unit 110 stores a variety of information.

Here, a process executed by the information processing device 100 will be briefly described below. The information processing device 100 acquires an image of a stranded wire. The information processing device 100 detects a length for acquiring images of the stranded wire in the same pattern based on the image of the stranded wire. In the following, the process executed by the information processing device 100 will be described in detail.

The acquisition unit 120 may acquire an image including a stranded wire. For example, the acquisition unit 120 acquires the image from the storage unit 110. Further, for example, the acquisition unit 120 acquires the image from a camera. Furthermore, for example, the acquisition unit 120 acquires the image from an external device. Incidentally, the external device is a cloud server, for example. Illustration of the external device is left out.

Further, the stranded wire is, for example, an electric wire, a wire supporting a utility pole, a wire supporting a bridge, or the like.

The acquisition unit 120 may acquire an extracted image of the stranded wire from the image including the stranded wire. In other words, the acquisition unit 120 may acquire an extracted image region of the stranded wire from the image including the stranded wire. Incidentally, the extraction process may be executed by the information processing device 100.

The acquisition unit 120 acquires an image of the stranded wire. As mentioned above, the acquisition unit 120 may acquire an extracted image of the stranded wire. Further, the acquisition unit 120 may acquire the image of the stranded wire from the storage unit 110 or an external device.

When the image of the stranded wire is not level, the transformation unit 130 performs geometric transformation so that the image of the stranded wire becomes level. Here, a case where the image of the stranded wire is made level will be shown below by using a concrete example.

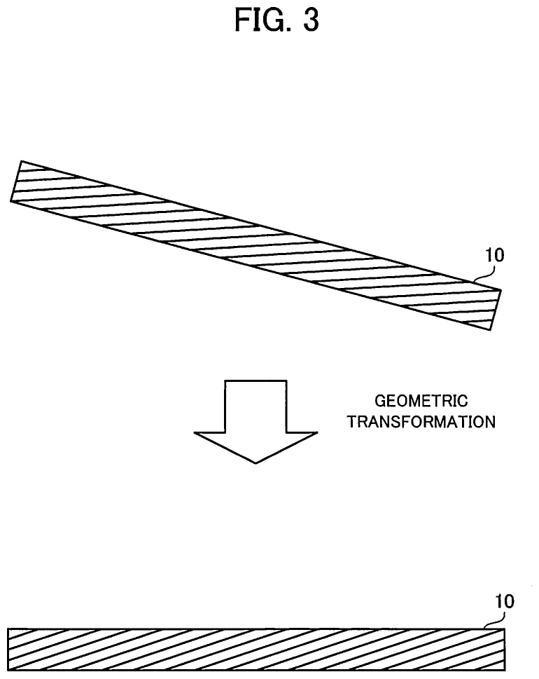

FIG. 3 is a diagram showing an example of the geometric transformation in the first embodiment. An upper part of FIG. 3 indicates that the image 10 of the stranded wire is not level. When the image 10 is not level, the transformation unit 130 performs the geometric transformation so that the image 10 becomes level. By this transformation, the image 10 becomes level.

The acquisition unit 120 acquires a reference image indicating the stranded wire. Further, the calculation unit 140 calculates a similarity level of a comparative image in the image of the stranded wire and the reference image. Here, the calculation of the similarity level will be described below by using concrete examples.

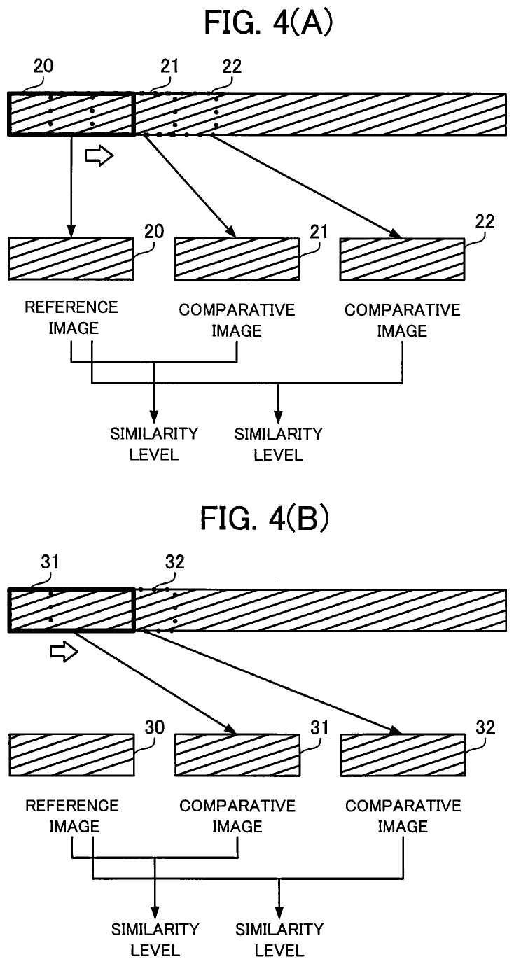

FIGS. 4(A) and 4(B) are diagrams showing examples of the calculation of the similarity level in the first embodiment. FIG. 4(A) is a diagram showing an example (No. 1) of the calculation of the similarity level. The acquisition unit 120 acquires an image of a predetermined length as the reference image from the image of the stranded wire. FIG. 4(A) shows the reference image 20.

The acquisition unit 120 acquires an image obtained by shifting the reference image 20 rightward by one pixel and being an image of the predetermined length (i.e., image of the same size as the reference image 20) as a comparative image. By this, the comparative image 21 is acquired.

The calculation unit 140 calculates the similarity level of the reference image 20 and the comparative image 21. Specifically, the calculation unit 140 calculates the similarity level by using technology of template matching. For example, the calculation unit 140 calculates the similarity level by using normalized cross-correlation. Specifically, the calculation unit 140 calculates the similarity level by using expression (1). Incidentally, R represents the similarity level. N represents a vertical length of the reference image or the comparative image. M represents a horizontal length of the reference image or the comparative image. I(i, j) represents a pixel value of the comparative image at the i-th row and the j-th column. T(i, j) represents a pixel value of the reference image at the i-th row and the j-th column.

$${R}_{NCC} = \frac{{\sum }_{j = 0}^{N - 1} {\sum }_{i = 0}^{M - 1} I ( i , j ) T ( i , j )}{\sqrt{{\sum }_{j = 0}^{N - 1} {\sum }_{i = 0}^{M - 1} {I ( i , j )}^{2} \times {\sum }_{j = 0}^{N - 1} {\sum }_{i = 0}^{M - 1} {T ( i , j )}^{2}}} \qquad ( 1 )$$

Further, for example, the calculation unit 140 calculates the similarity level by using a Sum of Squared Difference (SSD). Specifically, the calculation unit 140 calculates the similarity level by using expression (2). Incidentally, each symbol used in the expression (2) has the same meaning as that used in the expression (1).

$${R}_{SSD} = {\sum }_{j = 0}^{N - 1} {\sum }_{i = 0}^{M - 1} {( I ( i , j ) - T ( i , j ) )}^{2} \qquad ( 2 )$$

Subsequently, the acquisition unit 120 acquires an image obtained by shifting the comparative image 21 rightward by one pixel and being an image of the predetermined length (i.e., image of the same size as the reference image 20) as a comparative image. By this, the comparative image 22 is acquired. The calculation unit 140 calculates the similarity level of the reference image 20 and the comparative image 22.

The information processing device 100 repeats the acquisition of a comparative image and the calculation of the similarity level. As above, the information processing device 100 acquires a plurality of comparative images by the shifting image by image. The information processing device 100 calculates the similarity level of the reference image and each of the plurality of comparative images. By this, a plurality of similarity levels is obtained.

In FIG. 4(A), the case where the reference image 20 is acquired from the image of the stranded wire has been explained. A case where the reference image is not acquired from the image of the stranded wire will be explained below.

FIG. 4(B) is a diagram showing an example (No. 2) of the calculation of the similarity level. The acquisition unit 120 acquires a reference image 30 as an image of a predetermined length from the storage unit 110 or the external device.

The acquisition unit 120 acquires an image of the predetermined length (i.e., image of the same size as the reference image 30) as a comparative image from the image of the stranded wire. By this, the comparative image 31 is acquired.

The calculation unit 140 calculates the similarity level of the reference image 30 and the comparative image 31. Specifically, the calculation unit 140 calculates the similarity level by using the technology of the template matching.

Subsequently, the acquisition unit 120 acquires an image obtained by shifting the comparative image 31 rightward by one pixel and being an image of the predetermined length (i.e., image of the same size as the reference image 30) as a comparative image. By this, the comparative image 32 is acquired. The calculation unit 140 calculates the similarity level of the reference image 30 and the comparative image 32.

The information processing device 100 repeats the acquisition of a comparative image and the calculation of the similarity level. As above, the information processing device 100 acquires a plurality of comparative images by the shifting image by image. The information processing device 100 calculates the similarity level of the reference image and each of the plurality of comparative images. By this, a plurality of similarity levels is obtained.

The detection unit 150 detects a length for dividing the image of the stranded wire by using the plurality of similarity levels. In other words, the detection unit 150 detects the length for acquiring images of the stranded wire in the same pattern by using the plurality of similarity levels. Here, the detection process will be described below by using a concrete example.

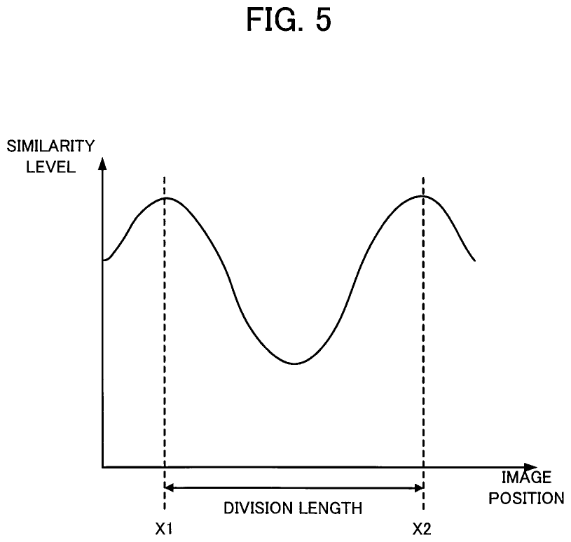

FIG. 5 is a diagram showing a concrete example of the detection process in the first embodiment. FIG. 5 is a diagram indicating the relationship between the plurality of similarity levels and image positions as a graph. The vertical axis represents the similarity level. The horizontal axis represents the image position.

The detection unit 150 detects an image position X1 where the similarity level is high. Further, the detection unit 150 detects an image position X2 where the similarity level is high. The detection unit 150 detects the length between the image position X1 and the image position X2 as the length for dividing the image of the stranded wire. When the image of the stranded wire is divided by the detected length, the pattern of the stranded wire in each image becomes the same as each other.

The above description has been given of the information processing device 100 repeating the acquisition of a comparative image and the calculation of the similarity level. The number of repetitions is greater than or equal to the number of times the division length can be detected.

After detecting the division length, the information processing device 100 may execute the following process. The information processing device 100 divides the image of the stranded wire by this length. The information processing device 100 inspects whether the stranded wire is normal or not by using a plurality of divided images obtained by the division. Incidentally, the information processing device 100 may execute the inspection by using a publicly known technology.

Next, a process executed by the information processing device 100 will be described below by using a flowchart.

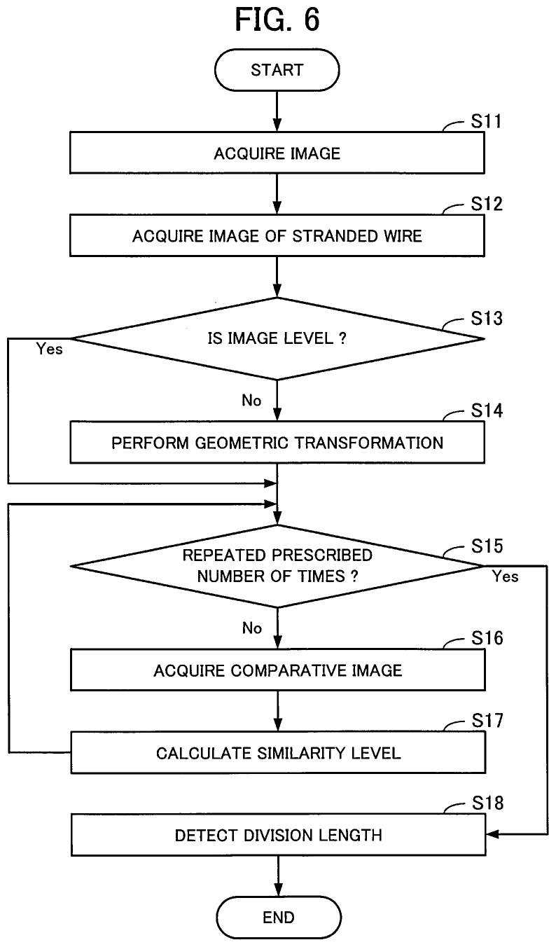

FIG. 6 is a flowchart showing an example of the process executed by the information processing device in the first embodiment.

(Step S11) The acquisition unit 120 acquires an image including the stranded wire.

(Step S12) The acquisition unit 120 acquires an image of the stranded wire from the image.

(Step S13) The transformation unit 130 judges whether the image of the stranded wire is level or not. When the image of the stranded wire is level, the process advances to step S15. When the image of the stranded wire is not level, the process advances to step S14.

(Step S14) The transformation unit 130 performs the geometric transformation so that the image of the stranded wire becomes level.

(Step S15) The calculation unit 140 judges whether or not the preceding processing has been repeated a predetermined number of times. When the condition is satisfied, the process advances to step S18. When the condition is not satisfied, the process advances to step S16.

(Step S16) The acquisition unit 120 acquires a comparative image from the image of the stranded wire. For example, the acquisition unit 120 acquires an image obtained by shifting the reference image rightward by one pixel as the comparative image. Further, for example, the acquisition unit 120 acquires an image obtained by shifting the previously acquired comparative image rightward by one pixel as the comparative image to be used in step S17.

(Step S17) The calculation unit 140 calculates the similarity level of the reference image and the comparative image. Then, the process advances to the step S15.

(Step S18) The detection unit 150 detects the length for dividing the image of the stranded wire by using the plurality of similarity levels.

According to the first embodiment, the information processing device 100 detects the length for dividing the image of the stranded wire by using the plurality of similarity levels. When the image of the stranded wire is divided by the detected length, the pattern of the stranded wire in each image becomes the same as each other. Thus, the information processing device 100 is capable of detecting the length for acquiring images of the stranded wire in the same pattern.

### Second Embodiment

Next, a second embodiment will be described below. In the second embodiment, the description will be given mainly of features different from those in the first embodiment. In the second embodiment, the description is omitted for features in common with the first embodiment.

In the second embodiment, a description will be given of a case where the information processing device detects the division length by a method different from that in the first embodiment.

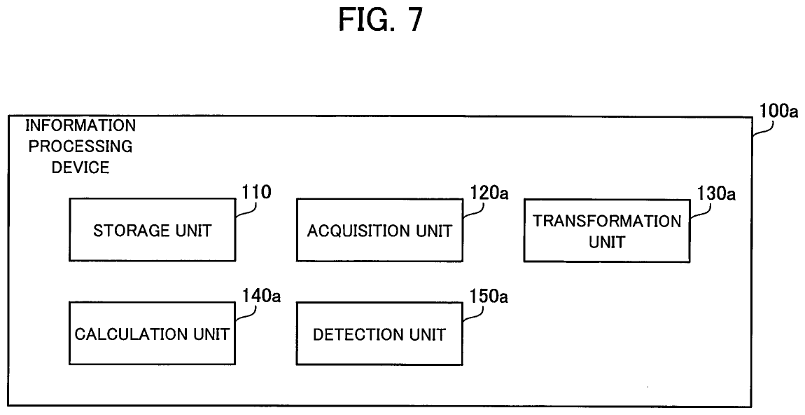

FIG. 7 is a block diagram showing functions of an information processing device in the second embodiment. The information processing device 100a includes the storage unit 110, an acquisition unit 120a, a transformation unit 130a, a calculation unit 140a and a detection unit 150a.

Part or all of the acquisition unit 120a, the transformation unit 130a, the calculation unit 140a and the detection unit 150a may be implemented by processing circuitry. Further, part or all of the acquisition unit 120a, the transformation unit 130a, the calculation unit 140a and the detection unit 150a may be implemented as modules of a program executed by the processor 101.

The acquisition unit 120a acquires an image of the stranded wire. For example, the acquisition unit 120a may acquire an extracted image of the stranded wire. Further, the acquisition unit 120a may acquire the image of the stranded wire from the storage unit 110 or the external device.

When the image of the stranded wire is not level, the transformation unit 130a performs the geometric transformation so that the image of the stranded wire becomes level.

The transformation unit 130a may transform the image of the stranded wire to a gray scale image. In the following description, it is assumed that the image of the stranded wire is transformed to the gray scale image.

The transformation unit 130a transforms the image of the stranded wire by using a window function. The window function is a Hann window, for example. For example, when the Hann window is used, the image after the transformation is represented by expression (3). Specifically, by the expression (3), the pixel value at the y-th row and the x-th column after the transformation is represented as v_{x1,y1}.

$${v}_{x 1 , y 1} = {v}_{x , y} {w}_{x} ( x ) {w}_{y} ( y ) \qquad ( 3 )$$

Here, v_{x,y} represents the pixel value at the y-th row and the x-th column before the transformation, and wₓ(x) is represented by expression (4).

$${w}_{x} ( x ) = 0.5 - 0.5 cos 2 π \frac{x}{X} \qquad ( 4 )$$

X represents the horizontal length of the image of the stranded wire, and w_{y}(y) is represented by expression (5).

$${w}_{y} ( y ) = 0.5 - 0.5 cos 2 π \frac{y}{Y} \qquad ( 5 )$$

Y represents the vertical length of the image of the stranded wire.

Here, an image example of the image after the transformation will be shown below.

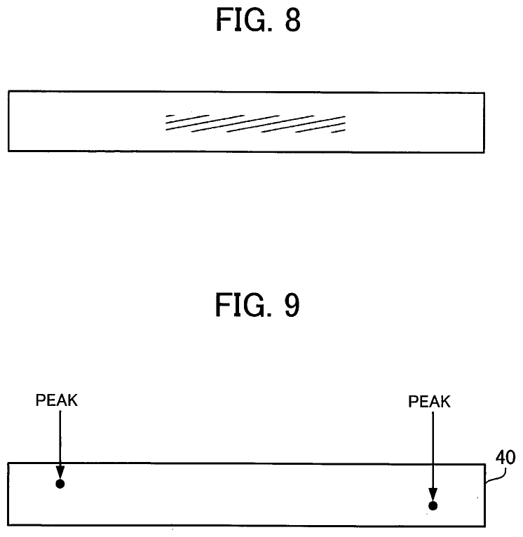

FIG. 8 is a diagram showing an image example of the image after the transformation in the second embodiment. FIG. 8 shows the image after the transformation when the Hann window is used.

The transformation unit 130a performs Fourier transform on the image transformed by using the window function. By this, an amplitude spectrum image is obtained. An example of the amplitude spectrum image will be shown below.

FIG. 9 is a diagram showing an example of the amplitude spectrum image in the second embodiment. FIG. 9 indicates peaks of the amplitude spectrum image 40. The peak is the highest value among the pixel values of the amplitude spectrum image 40. Incidentally, when a peak appears at an edge of the amplitude spectrum image 40, the peak is excluded. That is, when a peak appears at an edge of the amplitude spectrum image 40, the second highest pixel value is regarded as the peak in the second embodiment. Further, the peaks appear symmetrically in regard to the horizontal and vertical directions. Furthermore, the position representing the peak of the amplitude spectrum image 40 is represented by a frequency. Specifically, when the horizontal direction of the amplitude spectrum image 40 is defined as an x direction, the x-coordinate of the position representing the peak is represented by a frequency.

FIG. 9 indicates two peaks. The calculation unit 140a executes the following calculation by using the frequency represented by the position representing either one of the peaks.

The calculation unit 140a calculates a cycle T by using the frequency. Specifically, the calculation unit 140a calculates the cycle T by using expression (6). Incidentally, f represents the frequency. X represents the horizontal length of the image of the stranded wire.

$$T = \frac{X}{f} \qquad ( 6 )$$

The cycle T is the length for acquiring images of the stranded wire in the same pattern. The detection unit 150a may also detect the cycle T as the length for dividing the image of the stranded wire.

Next, a process executed in the second embodiment will be described below by using a flowchart.

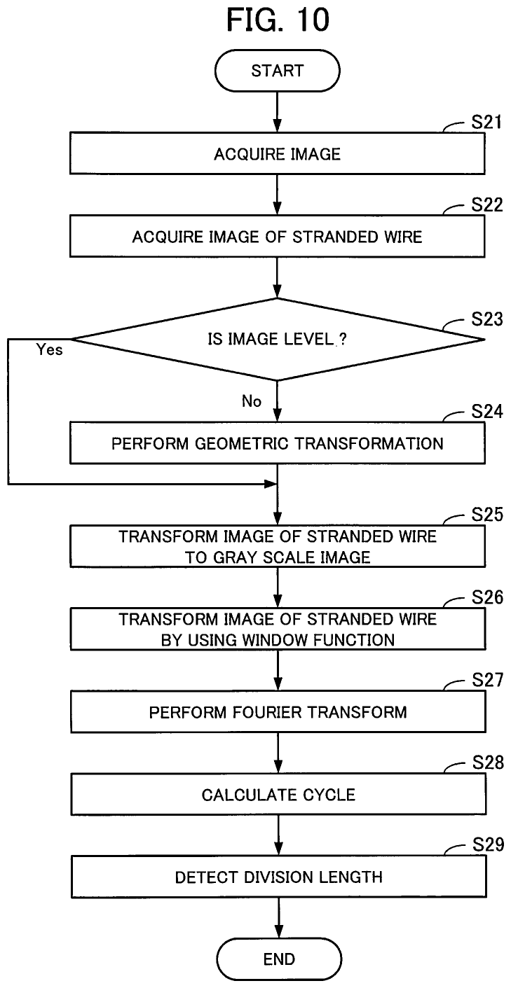

FIG. 10 is a flowchart showing an example of the process executed by the information processing device in the second embodiment.

(Step S21) The acquisition unit 120a acquires an image including the stranded wire.

(Step S22) The acquisition unit 120a acquires an image of the stranded wire from the image.

(Step S23) The transformation unit 130a judges whether the image of the stranded wire is level or not. When the image of the stranded wire is level, the process advances to step S25. When the image of the stranded wire is not level, the process advances to step S24.

(Step S24) The transformation unit 130a performs the geometric transformation so that the image of the stranded wire becomes level.

(Step S25) The transformation unit 130a transforms the image of the stranded wire to the gray scale image.

(Step S26) The transformation unit 130a transforms the image of the stranded wire by using a window function.

(Step S27) The transformation unit 130a performs Fourier transform on the image transformed by using the window function. By this, the amplitude spectrum image is obtained.

(Step S28) The calculation unit 140a calculates the cycle T by using the frequency represented by the position representing the peak of the amplitude spectrum image.

(Step S29) The detection unit 150a detects the cycle T as the length for dividing the image of the stranded wire.

According to the second embodiment, the information processing device 100a detects the cycle T as the length for dividing the image of the stranded wire. When the image of the stranded wire is divided by the detected length, the pattern of the stranded wire in each image becomes the same as each other. Thus, the information processing device 100a is capable of detecting the length for acquiring images of the stranded wire in the same pattern.

Features in the embodiments described above can be appropriately combined with each other.

### DESCRIPTION OF REFERENCE CHARACTERS

10: image, 20: reference image, 21: comparative image, 22: comparative image, 30: reference image, 31: comparative image, 32: comparative image, 40: amplitude spectrum image, 100: information processing device, 100a: information processing device, 101: processor, 102: volatile storage device, 103: nonvolatile storage device, 110: storage unit, 120: acquisition unit, 120a: acquisition unit, 130: transformation unit, 130a: transformation unit, 140: calculation unit, 140a: calculation unit, 150: detection unit, 150a: detection unit

What is claimed is:

1. An information processing device comprising:
acquiring circuitry to acquire an image of a stranded wire, acquire a reference image indicating a stranded wire, and acquire a plurality of comparative images from the image;
calculating circuitry to calculate a similarity level of the reference image and each of the plurality of comparative images; and
detecting circuitry to detect a length for acquiring images of the stranded wire in a same pattern by using a plurality of the similarity levels,
wherein
each of the plurality of comparative images is an image of a same size as the reference image.

2. The information processing device according to claim 1, further comprising transforming circuitry to perform geometric transformation so that the image of the stranded wire becomes level when the image of the stranded wire is not level.

3. An information processing device comprising:
acquiring circuitry to acquire an image of a stranded wire;
transforming circuitry to transform the image of the stranded wire by using a window function and perform Fourier transform on the image transformed by using the window function;
calculating circuitry to calculate a cycle by using a frequency represented by a position representing a peak of an amplitude spectrum image as an image obtained by the Fourier transform; and
detecting circuitry to detect the cycle as a length for acquiring images of the stranded wire in a same pattern.

4. The information processing device according to claim 3, wherein the transforming circuitry transforms the image of the stranded wire to a gray scale image.

5. The information processing device according to claim 3, wherein the transforming circuitry performs geometric transformation so that the image of the stranded wire becomes level when the image of the stranded wire is not level.

6. A detection method performed by an information processing device, the detection method comprising:
acquiring an image of a stranded wire;
acquiring a reference image indicating a stranded wire, and acquiring a plurality of comparative images from the image;
calculating a similarity level of the reference image and each of the plurality of comparative images; and
detecting a length for acquiring images of the stranded wire in a same pattern by using a plurality of the similarity levels,
wherein
each of the plurality of comparative images is an image of a same size as the reference image.

7. A detection method performed by an information processing device, the detection method comprising:
acquiring an image of a stranded wire;
transforming the image of the stranded wire by using a window function;
performing Fourier transform on the image transformed by using the window function;
calculating a cycle by using a frequency represented by a position representing a peak of an amplitude spectrum image as an image obtained by the Fourier transform; and
detecting the cycle as a length for acquiring images of the stranded wire in a same pattern.

8. An information processing device comprising:
a processor to execute a program; and
a memory to store the program which, when executed by the processor, performs processes of,
acquiring an image of a stranded wire,
acquiring a reference image indicating a stranded wire, and acquiring a plurality of comparative images from the image,
calculating a similarity level of the reference image and each of the plurality of comparative images, and
detecting a length for acquiring images of the stranded wire in a same pattern by using a plurality of the similarity levels,
wherein
each of the plurality of comparative images is an image of a same size as the reference image.

9. An information processing device comprising:
a processor to execute a program; and
a memory to store the program which, when executed by the processor, performs processes of,
acquiring an image of a stranded wire,
transforming the image of the stranded wire by using a window function,
performing Fourier transform on the image transformed by using the window function,
calculating a cycle by using a frequency represented by a position representing a peak of an amplitude spectrum image as an image obtained by the Fourier transform, and
detecting the cycle as a length for acquiring images of the stranded wire in a same pattern.
